(19) United States
(12) Patent Application Publication
(10) Pub. No.: US 2008/0002680 A1
(43) Pub. Date: Jan. 3, 2008

(54) Method and system for variable viability summarization in communication networks

(75) Inventors: Darek Skalecki, Kanata (CA); Donald Fedyk, Groton, MA (US)

Correspondence Address: CHRISTOPHER & WEISBERG, P.A., 200 EAST LAS OLAS BOULEVARD, SUITE 2040, FORT LAUDERDALE, FL, 33301, US

(73) Assignee: NORTEL NETWORKS LIMITED.

(21) Appl. No.: 11/479,447

(22) Filed: Jun. 30, 2006

(51) Int. Cl. H04L 12/56

(52) U.S. Cl. 370/389

(57) ABSTRACT

A method and apparatus for summarizing port viability information in a communication network. A port viability summarization in the form of a table or matrix is established for ports in the communication network in which the port viability summarization is used to establish links to use along a routing path. A routing path is determined using the port viability summarization. A failed route establishment for the routing path is detected. The amount of summarization is decreased for at least one port determined to have a non-viable link.

### CROSS-REFERENCE TO RELATED APPLICATIONS

n/a

### STATEMENT REGARDING FEDERALLY SPONSORED RESEARCH OR DEVELOPMENT

n/a

### BACKGROUND OF THE INVENTION

1. Field of the Invention

The present invention relates to networking and in particular to a method and system for summarizing route viability information within a network such as an optical network.

2. Description of the Related Art

The ever increasing demand being placed on networks for high speed bandwidth and application support combined with the availability of affordable access to large scale networks such as the Internet has fueled the development of optical networking technologies and the deployment of optical networks themselves. Optical networking uses the photonic energy applied to various wavelengths of light, typically through fiber optic cable and associated lightwave switching and routing hardware, to transmit information.

As any network grows, so to do the scalability challenges associated with the growth. This is particularly the case with optical networks where the optical switches used to switch the optical signal from a particular input port to an output port for further transmission are typically blocking switches. Blocking switches are switches in which an input can not necessarily be switched to all outputs. This is in contrast to non-blocking switches typically found in physical layer switches of electrically based networks. For example, Synchronous Optical Network (“SONET”) and Asynchronous Transfer Mode (“ATM”) networks use electronic switches to switch input ports to output ports. Because the switching at Open System Interconnection (“OSI) Layer 0 (the physical layer), occurs at the electronic level as opposed to the optical level, switches can be designed so that any input port can be switched to any non-busy output port, with additional buffering and queuing used to output to a busy port. Such is not the case with pure optical switching at OSI Layer 0.

Optical signals are transmitted using a predetermined wavelength from a group of wavelengths within the network. While switches are typically arranged to be able to switch this group of wavelengths, optical signals using different wavelengths can interfere with each other and lead to the problem where one or more wavelengths appearing at an input port can not be switched to an output port. The result is that the optical switch becomes a blocking switch for certain combinations of wavelengths. Put another way, only a subset of output ports are available for a given wavelengths. Of note, determining which wavelengths are blocked is beyond the scope of this invention.

The need to describe output port availability is driven, in part, by the need to determine network routing. However, the blocking nature, by wavelength, of optical switching equipment creates a scaling problem when trying to describe, for every input port, which port can serve as an output port and for which wavelengths. Such a description is needed to provide routing updates to other devices in the network for the establishment and maintenance of routing tables, e.g., Open Shortest Path First (“OSPF”) tables. Explicitly specifying port to port viability is impractical because of size of the tables needed to store the viability information will quickly get very large when large switches, e.g., switches with 1000 ports, are used. As such, it is desirable to be able to summarize port viability information in a manner that reduces the size of the tables and minimizes the size of routing updates.

The format of routing updates, including extensions, for networking technologies such as SONET, i.e. non blocking technologies, is well known, e.g., the OSPF-Traffic Engineering (“OSPF-TE”) extensions for Generalized Multi-Protocol Label Switching (“GMPLS”). Many of these formats, including the OSPF-TE extensions, can be extended in a scalable fashion. However, networks such as photonic networks typically use one protocol to establish and update routing, e.g., OSPF-TE, and another protocol, such as Resource Reservation Protocol-Traffic Engineering (“RSVP-TE”), for signaling to negotiate an end-to-end viable path along the route computed using OSPF-TE. As such, there is a cooperation between the routing protocol and the signaling protocol.

As a result of this cooperation, if any attempt to summarize viable wavelength information is used (as opposed to creating huge routing tables that include detailed wavelength-based viability information), while OSPF-TE may indicate that a route exists, the signaling system may indicate there is no viable path at the time the path connection is being made. Rather than simply wait for the signaling system to make this determination, it is desirable to have a system and method that can dynamically address the summarization issue and adjust the routing table to include a summary that represents actual viable routes through the network.

### SUMMARY OF THE INVENTION

The present invention advantageously provides a method and system for efficiently summarizing port viability information in a network such as an optical network in a manner that allows routing algorithms to consider the viability when establishing routing paths yet also allows for the “granularization” and expansion of the viability data as network utilization and port viability changes.

In accordance with one aspect, the present invention provides a method for summarizing port viability information in a communication network. A port viability summarization in the form of a table or matrix is established for ports in the communication network in which the port viability summarization is used to establish links to use along a routing path. A routing path is determined using the port viability summarization. A failed route establishment for the routing path is detected. The amount of summarization is decreased for at least one port determined to have a non-viable link.

In accordance with another aspect, the present invention provides a machine readable storage device having stored thereon a computer program for summarizing port viability information in a communication network. The computer program includes a set of instructions which when executed by a machine causes the machine to perform a method in which a port viability summarization in the form of a table or matrix is established for ports in the communication network in which the port viability summarization is used to establish links to use along a routing path. A routing path is determined using the port viability summarization. A failed route establishment for the routing path is detected. The amount of summarization is decreased for at least one port determined to have a non-viable link.

In accordance with still another aspect, the present invention provides an apparatus for summarizing port viability information in a communication network, the apparatus has a central processing unit and a storage device. The central processing unit establishes a port viability summarization for ports in the communication network. The port viability summarization is used to establish links to use along a routing path. The central processing unit also determines routing path using the port viability summarization, detects a failed route establishment for the routing path and decreases the amount of summarization for at least one port determined to have a non-viable link. The storage unit stores the port viability summarization.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a diagram of a system constructed in accordance with the principles of the present invention;

FIG. 2 is a table constructed in accordance with the principles of the present invention showing an initial port viability summarizations;

FIG. 3 is a table constructed in accordance with the principles of the present invention showing port viability summarizations after a first iteration;

FIG. 4 is a table constructed in accordance with the principles of the present invention showing steady state port viability summarizations;

FIG. 5 is a flow chart of a port viability summarization process of the present invention; and

FIG. 6 is a diagram of an alternative embodiment of a system constructed in accordance with the principles of the present invention.

### DETAILED DESCRIPTION OF THE INVENTION

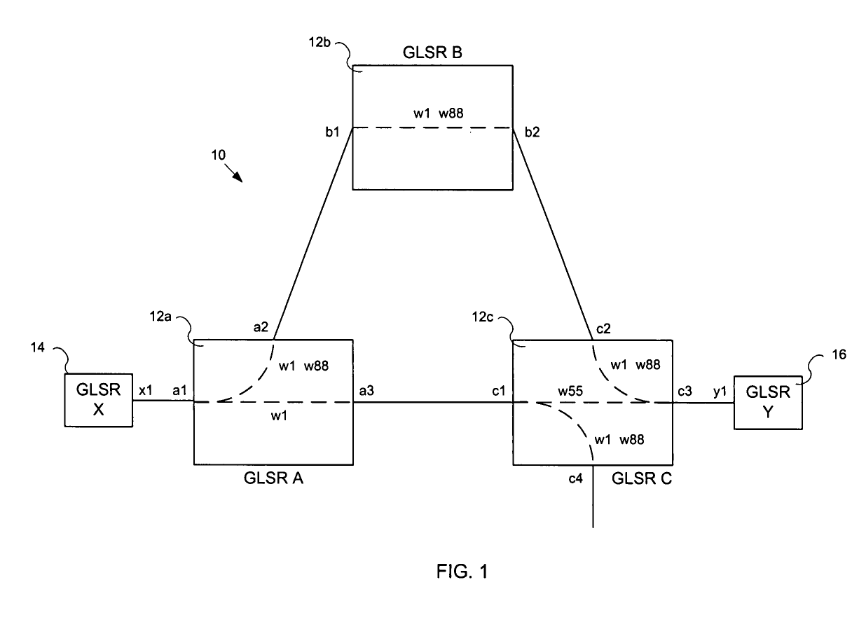

Referring now to the drawing figures in which like reference designators refer to like elements, there is shown in FIG. 1 an optical networking system constructed in accordance with the principles of the present invention and designated generally as “10”. System 10 includes one or more domains each of which is supported by a generalized label switch router (“GLSR”) 12a-c (referred to collectively herein as GLSR 12). For example, domain A is supported by GLSR A 12a, domain B is supported by GLSR B 12b and GLSR C 12c supports domain C. Although it is noted that system 10 typically includes many domains 12, for ease of explanation FIG. 1 shows only three GLSRs 12a-c. System 10 also includes GLSR X 14 (supporting domain X) and GLSR Y 16 (supporting domain Y). GLSRs X 14 and Y 16 are described separately from GLSRs 12 for ease of explanation of the viability summarization process and resultant routes of the present invention, it being understood that GLSRs X 14 and Y 16 themselves need not be structurally or functionally different from GLSRs 12.

Hardware for GLSRs 12 (and 14 and 16) can be hardware as may be known in the art to store routing tables and for supporting routing functions, including the routing functions and tables of the present invention. By way of non-limiting example, a GLSR 14 constructed in accordance with the principles of the present invention includes a central processing unit, volatile and non-volatile memory, input/output device(s) and network interface(s).

As is shown in FIG. 1, each GLSR includes one or more ports, designated by the lower case letter and numeral adjacent each interface to a corresponding GLSR. For example, GLSR A 12a includes three ports designated as “a1”, “a2” and “a3”. GLSR 12b includes two ports designated as “b1” and “b2”. GLSR 12c includes four ports designates as “c1”, “c2”, “c3” and “c4”. GLSRs X 14 and Y 16 include ports “x1” and “y1”, respectively. Also shown in FIG. 1 are the light wavelength numbers supported within each GLSR as viable from an ingress port to an egress port. As is described herein, photonic transmission from one port to another within a GLSR 12 may not be possible for any or all wavelengths. As such, any to any communication between ports within a GLSR 12 is not guaranteed. As a result, egress from a GLSR 12 may not be possible for data entering the GLSR 12 from a particular port. For example, communication of data transported at a wavelength entering GLSR 12a via port a1 at other than wavelength numbers 1 and 88 means that this data can not egress GLSR 12a because communication from within GLSR 12a from port a1 is not be possible at other wavelengths. The determination as to which wavelengths can be used within a GLSR 12 for port to port communications in beyond the scope of this invention, it being understood that methods and systems for making such determinations are known.

As is discussed below in detail, GLSRs 12 maintain a table that includes viability information for ingress port to egress port viability for their corresponding domains. This viability specifies the range of wavelengths that can be switched from an ingress port to an egress port through the GLSR 12. If port to port viability is known, a route can be efficiently determined for a given wavelength and optical format. Of note, formats for optical communication, such as the G709 format, are known.

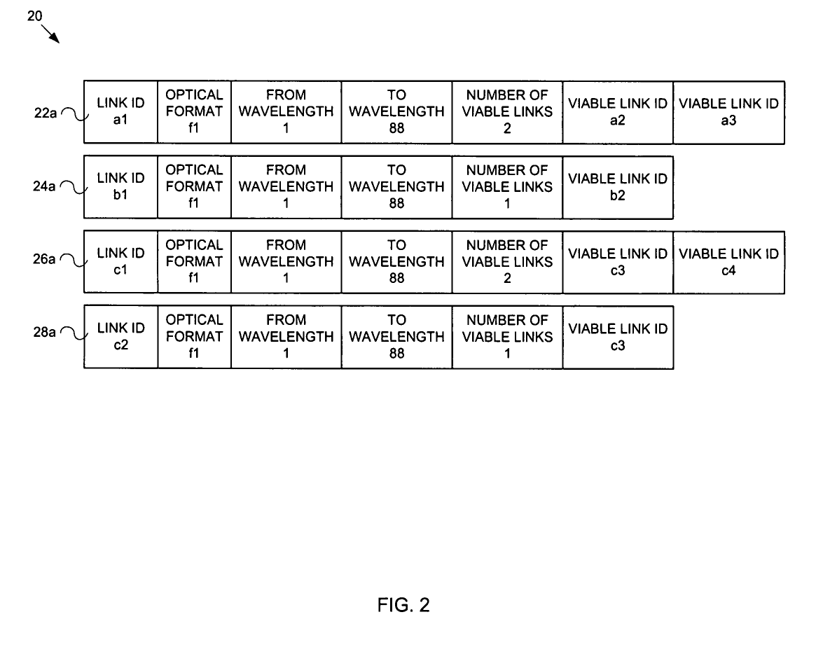

Routes can be determined using the port information and a TLV that includes summarized viability information. An exemplary port summarization table 20 is described with reference to FIG. 2. The TLV for port summarization table 20 includes fields for the link ID, optical format, wavelength (“λ”) range (shown as from wavelength and to wavelength), the number of viable links that can be used to support the wavelength range and a list of link IDs for the corresponding number of viable links. Multiple from and to wavelength, number of viable links and list of viable link IDs fields are used for each viable range for a given link ID and optical format. Examples are shown and described below.

A row (also referred to herein as a TLV) in the matrix is established for each link ID/optical format combination. For the sake of simplicity, the present invention is described with reference to a single optical format “f1”. Initially, a row is established with the least granular, i.e., broadest summarization possible for each link ID. Table 20 shows a set of rows established as the initial summarization for the links in FIG. 1. Each of rows 22a-28a in table 20 corresponds to a particular ingress link for the GLSRs 12 in FIG. 1. These rows are used to establish a path from GLSR X 14 to GLSR Y 16. It is understood that another set of rows (not shown) are used to establish a path from GLSR Y 16 to GLSR X 14. For ease of understanding, the present invention is described with respect to communication from GLSR X 14 to GLSR Y 16, it being understood that the same teachings set out herein are used to establish a path in the reverse direction.

Initial summarization table 20 includes row 22a, corresponding to initial viability summarization for link ID a1 using optical format f1. Initially, row 22a includes viability data showing that, from wavelengths 1 to 88, there are two viable links for egress, namely viable links a2 and a3. Initially, row 24a includes viability data showing that, from wavelengths 1 to 88, there is only one viable link for egress, namely viable link b2. Initially, row 26a includes viability data showing that, from wavelengths 1 to 88, there are two viable links for egress, namely viable links c3 and c4. Initially, row 28a includes viability data showing that, from wavelengths 1 to 88, there is only one viable link for egress, namely viable link c3. Populating the matrix in this manner is the starting point. It is readily apparent from FIG. 1 that this summarization is too broad, as not all wavelengths in the specified range are viable. For example, the link from a3 to c1 only supports wavelength number 1 (from port a1) while egress port c3 only supports wavelength 55 from ingress port c1. An iterative process is performed to further summarize, i.e. “granularize”, the viability information to the point where it accurately describes the viable port information. Such can be triggered, for example, by the determination that a route using links a1, a3, c1, c3 is not viable.

Based on table 20, a route computed from GLSR X 14 to GLSR Y 16 would be computed as {GLSR X, x1, a1, GLSR A, a3, c1 GLSR C, c3, y1, GLSR Y}. By signaling, this route will be discovered as a non-viable route because only wavelength number 1 is supported through GLSR A 12a and only wavelength number 55 is supported through GLSR C 12c in this route. This feedback is used to initiate a process that will calculate a more granularized summarization for ports a1 and c1.

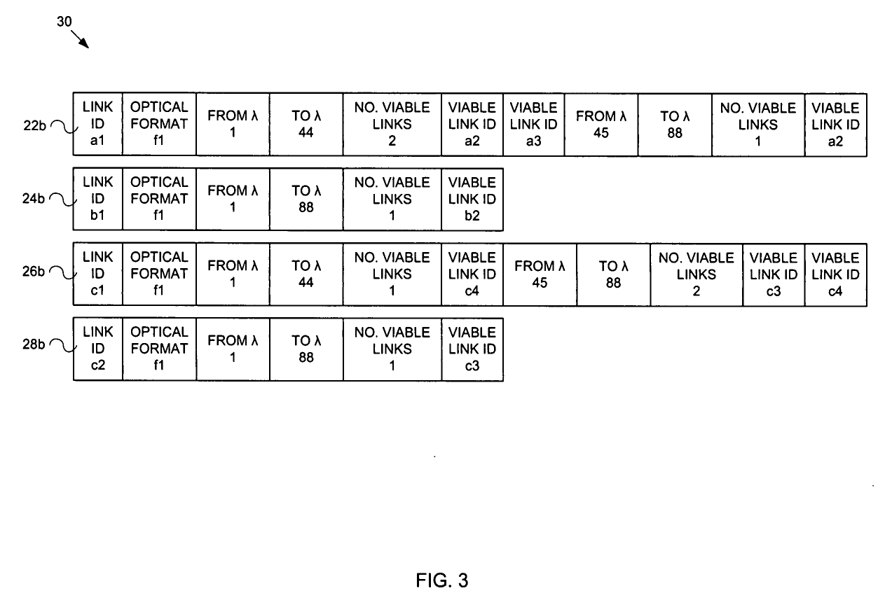

An exemplary interim viability summarization table 30 is described with reference to FIGS. 1 and 3. FIG. 3 shown interim viability summarization table 30, which is an example of the granularization of the viable links taken after the first iteration. Of note, although the iterative process shown and described herein is a binary process where each range is split in half until the granularization accurately reflects the viability, it is understood that any iterative process can be used as long as the steady state (point of equilibrium) port summarization table is accurate. Using a binary search paradigm to make summarizations more granular, the same route can be determined by the routing process up to a maximum of seven times (assuming 88 different wavelengths) before the routing process is steered to a different and potentially viable route.

After the first iteration, it can be seen that row 22a from FIG. 2 has been modified as row 22b to add a second set of summarization information. In row 22b, the wavelength range has been cut in half to include the second set of wavelength ranges. As such, row 22b includes wavelength numbers 1 to 44 and separate entries for wavelength numbers 45-88. Within these ranges, egress port a3, supporting only wavelength number 1 is only viable for the range that includes wavelength numbers 1-44. As such, the range that includes wavelength numbers 45-88 does not include egress port a3 as a viable egress port. Row 26b is similarly processed to show that link ID c3 is viable only for the range that includes wavelength numbers 45-88 while the range that includes wavelength numbers 1-44 is viable for link ID c4. Rows 24b and 28b have not been modified at this point because the feedback from the initial iteration did not require granularization of these rows. This is the case because the initially calculated route did not use GLRB 12b, so ports a2 and c2 were not implicated in the initial route.

Now, a route computed from GLSR X 14 to GLSR Y 16 is {GLSR X, x1, a1, GLSR A, a2, b1, GLSR B, b2, c2, GLSR C, c3 y1, GLSR Y}. This route can be successfully established by signaling for at least a group of wavelengths, in this case wavelength number 1.

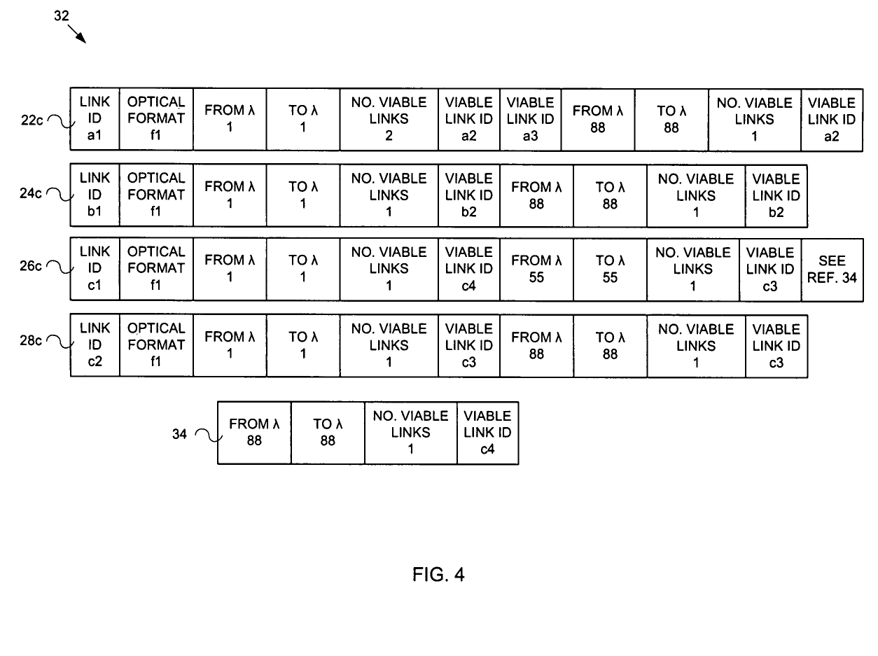

FIG. 4 shows a steady state summarization table 32 in which row 22c corresponds to steady state summarization for the corresponding data in rows 22a and 22b, row 24c corresponds to steady state summarization for the corresponding data in rows 24a and 24b, row 26c corresponds to steady state summarization for the corresponding data in rows 26a and 26b and row 28c corresponds to steady state summarization for the corresponding data in rows 28a and 28b.

As is shown, through an iterative process, row 22c has been expanded to show that wavelength number 1 is viable via links a2 and a3, while wavelength 88 is viable only via link a2. Row 24c shows that wavelength number 1 is viable via link b2, while wavelength 88 is also viable only via link b2. Row 26c, including expansion section 34 shows that wavelength number 1 is viable via link c4, while wavelength 55 is viable only via link c3 and wavelength 88 is viable via link c4. Finally, row 28c shows that wavelength number 1 is viable via link c3, while wavelength 88 is also viable only via link c3. Although not the case in the described example, if for example, there were multiple contiguous wavelength numbers that were viable from the same link, the to wavelength number would include the contiguous range.

As noted above, the port viability summarization table represented by tables 20, 30 and 32 includes data corresponding to the supported light wavelengths and optical formats for each port. Of course, it is understood that tables 20, 30 and 32 shown in FIGS. 2-4, respectively, correspond to different states of the same table as stored in a GLSR 12. Also, the fields shown in tables 20, 30 and 32 can be stored in any order. Likewise, although wavelength representation is shown in tables 20, 30 and 32 using an integer numbering scheme, other representations can also be used. For example, specifying frequencies instead of wavelengths or using alphanumeric characters to represent wavelengths or frequencies. Also, it is contemplated that a system can support less than or more than 88 different wavelengths. Similarly, networks that support a single optical format need not have a corresponding field in the port viability summary table.

The present invention advantageously minimizes the amount of memory required to advertise viable ports. For example, referring to FIGS. 2-4, assuming a 1,000 photonic port GLSR 12 and a network that supports up to 8 optical formats and 88 different wavelengths, the optical format field is 3 bits, the from and to wavelength fields are 7 bits. Allowing 10 bits for the length ID, 10 bits for the number of viable links and 10 bits for the viable link ID, for colored (fixed wavelengths) ports, there is one viability TLV per photonic port, so the worst case memory requirement is 1,000*(10+3+7+7+10+1,000*(10))\8=1.25 Mb advertised by each GLSR 12. Certainly, this is a manageable size. Of note, for a GLSR 12 with 400 ports, the memory requirement drops down to 202 Kb.

For colorless (wavelength tunable) ports, there is still one viability TLV per port, i.e. 1,000 in this example, but the portion of the viability TLV that includes the from wavelength, to wavelength, number of viable links and viable link ID list fields may be replicated up to the quantity of different wavelengths in the system, e.g., 88 times. In such a case, the worst case memory requirement is 1,000*(10+3+88*(14+10+1,000*(10)))\8=110 Mb. While 110 Mb may seem large, and perhaps not very manageable, this is a worst case scenario in which there is ostensibly no summarization. Using the summarization method of the present invention, summarizing the viability for the full range of wavelengths establishes the memory requirement at 1.25 Mb which is the same as for a colored port. As the network utilization increases and non-viable ports are being computed by the routing engine, more granular summarization is made available via feedback or flooding. As such, while the memory requirement will expand from 1.25 Mb, one would not expect the requirement to expand all the way to 110 Mb for colorless ports. Similarly, although granularization may increase the memory requirement, the present invention contemplates re-summarizing as port utilization drops, thereby decreasing memory requirements, as such becomes practical.

Of note, as network utilization grows, the number of viable ingress to egress port paths decreases since many of the 1,000 ports on a node are already utilized. Thus as the granularity increases, the list of viable link IDs in tables 20, 30 and 32 decreases. Thus it is extremely difficult to arrive at 110 Mb memory required for a utilized network. While the memory requirement may start at 1.25 Mb and increase as utilization increases to a certain level of X Mb, but then as utilization continues to increase, the memory requirements start coming down from the X Mb level.

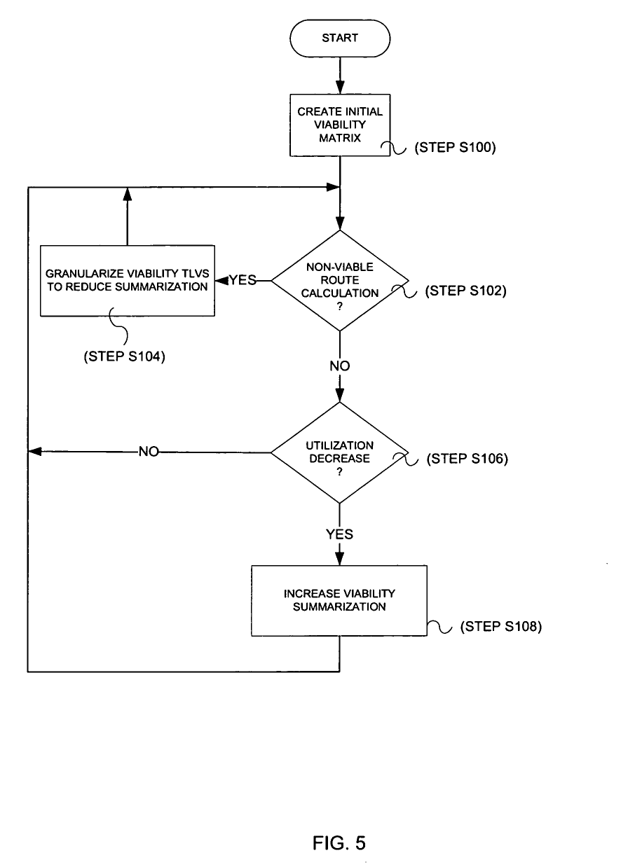

A process of a port viability summarization of the present invention is explained with reference to FIG. 5. As discussed above, the size of the TLV rows in the port viability matrix is based on the granularity of summarization that results from failed route establishments. Initially, a TVL summarization matrix (a group of summarization tables for different optical formats) is established having the greatest level of summarization, i.e., the least granular (step S100). The granularity of viability summarization is controlled by having GLSRs 12 monitor the frequency of the computation of non-viable paths by the routing engine. When a GLSR 12 determines LSP establishments through that GLSR 12 failed due to non-viable path calculation (step S102), that GLSR 12 raises its granularity level by decreasing the amount of summarization for a port that has a non-viable link along the calculated path (step S104).

The GLSR 12 is arranged to be able to raise the granularity level for particular ports rather than simply granularizing the summarization for all ports within a particular GLSR 12. For example, FIG. 3 shows interim table 20 in which rows 22b and 26b show iterative granularization, while rows 24b and 28b do not. Such may be the case because of failed LSP establishment due to the attempt to create a route using links a1 and c1, discussed above. On the other hand, steady state table 32 shows granularization of all rows in the table, such as may occur if there were failed LSP establishments for routes that ended up trying to use all of the links in the system. Put another way, the steady state table 32 in FIG. 5 represents a worst-case scenario in terms of granularization.

In addition to being able to raise the granularity level for particular photonic ports, GLSRs 12 are also able to monitor network utilization for decreases (step S106) and increase the level of summarization, i.e. lower the granularity level, such as occurs when network utilization drops because LSPs are terminated and wavelengths between ports become available (step S108). It is also contemplated that the viability summarization for a port can be increased after a predetermined period of time has elapsed, i.e., after the summarization for a particular port has aged. Increasing summarization for aged ports frees up memory to use for increasing the granularization (decreased summarization) for ports along failed routes. The result is an efficient utilization of storage memory resources.

Another way to control the granularity of summarization is for GLSRs 12 to pre-compute the size of the viability TLVs for the most granular summarization that falls within a predetermined memory requirement threshold. For example, a predetermined memory threshold of 1.25 Mb can be established as the most granular representation for which the size of the viability TLV summarization matrix (tables) does not exceed this value at its most granular rate. Such may be the case, as discussed above, with colored ports in a 1,000 photonic port GLSR 12. Of course, the factors that can influence the threshold are the number of GLSRs 12 and ports in the network as well as the amount of memory available within GLSRs 12. As another option, a memory threshold can be established so that the port viability summarization for ports in the communication network occupies an amount of memory that is approximately the memory threshold. For example, if it is determined that 20 Mb of memory should be dedicated to storing the viability TLV summarization tables, GLSRs 12 can operate to summarize as close to the 20 Mb threshold as possible.

It is also contemplated that another way for GLSRs 12 to control the granularity of summarization is to always flood the least granular summarization and utilize feedback to bring back more granular summarizations as LSP establishments fail. These summarizations can be inserted into the summarization table. A new route can be computed and these more granular summarizations discarded right after LSP establishment succeeds, or at some future time such as aging them or discarding them as memory is required for summarizations for another LSP which is unable to be established. Of course, this arrangement assumes that there is sufficient memory available in GLSRs 12 and sufficient processing capability in the GLSRs 12 to support this embodiment.

The methods and arrangements described above relate to describing port viabilities in the positive sense. In other words, the rows in tables 20, 30 and 32 (in FIGS. 2-4) show summarization from the standpoint of what ports are viable for a particular range of wavelengths. It is contemplated that such summarization and granularization can also be determined and tabularized in the negative sense, i.e., stating that ports with a particular wavelength range are not viable to certain other ports. Additionally, it is contemplated that such summarization and granularization can also be determined and tabularized to correspond to a range of wavelengths that are not available for egress from a particular ingress port. Both such arrangements might save memory if summarization of negative viabilities consumes less memory than summarization of positive viabilities. Although not shown in FIGS. 2-4, it is contemplated that an additional field can be added to the rows in the viability table to indicate whether the summarization is positive or negative or a flag included in the advertisement to indicate whether the viability information is positive or negative.

In accordance with another aspect, it may be sometimes useful to not send viability information for all of the wavelengths and/or egress ports. Such might be the case where it is desired not to expend a lot of memory when just a little more granularity will do. For such an arrangement, an indication is provided that the information is complete (summary is complete) or incomplete. In the latter case, an indication of incomplete summarization means that there are more wavelengths and/or egress ports viable if requested but for now they are not being transmitted. Here again, a flag in the advertisement (positive or negative) can be provided to indicate whether the list of wavelengths and/or viable ports is complete or incomplete. If path computation cannot find a route from source to destination, the GLSR 12 could ask the GLSRs 12 which sent incomplete advertisements to either send more complete advertisements or a different set of viable wavelengths and/or ports.

Of course, it is further contemplated that a combination of the above methods can be applied to control the granularity of summarization to ensure that memory is not only not exhausted, but is also efficiently utilized.

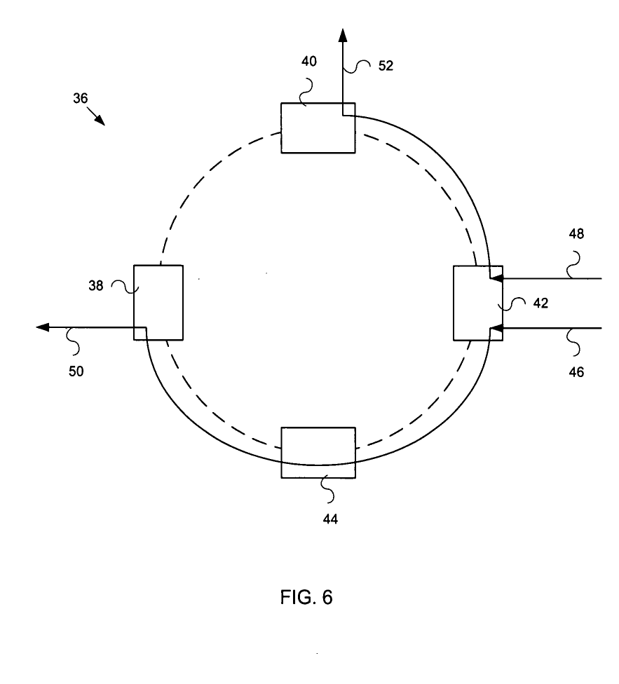

Although the present invention has been described thus far with respect to a network that employs photonic switching, it is contemplated that the present invention is also applicable to arrangements in which other forms of blocking within a switch may occur, such as in a synchronous optical network (“SONET”) arranged in a bi-directional line switch ring (“BLSR”). Such an arrangement is shown with reference to FIG. 6.

FIG. 6 shows network 36 including switches 38, 40, 42 and 44. For the sake of simplicity, only segments of the dual-ring structure relevant to explanation are shown. Switch 42 includes two active ingress ports 46 and 48 in which the circuit on ingress port 46 is switched through switch 44 and exits network 36 via egress port 50 on switch 38. The circuit inbound on ingress port 48 exits network 36 at the next hop switch 40 via egress port 52.

In accordance with the present invention, the time slots used to carry traffic can be summarized if network 36 is considered as one large switching element, such as the way a GLSR is considered within the context of the present invention. In such a scenario, network 36 is viewed as a series of ingress ports and egress ports in which certain time slots cannot be switched from one ingress port to another. For example, if traffic is present on ingress port 46 in a particular time slot, that time slot is unavailable for use as an ingress port in switch 44 because the time slot is used all the way through switch 44 to switch 38. As such, as with GLSRs where a particular wavelength may not be available for use between an ingress port and an egress port, time slots within network 38 may not be available between two ports. An attempt to create a route between a particular ingress port and egress port in network 38 may fail. Accordingly, a summarization table can be created in which the rows correspond to the ingress links, as with the arrangement described above with respect to GLSRs 12. The present invention can therefore be in a scenario in which there is some form of blocking between ingress ports and egress ports in a switch, group of switches, and the like.

The present invention therefore advantageously provides a method for summarizing port viability on a wavelength by wavelength basis in a manner which allows compact and efficient updating and route establishment. A device, such as a GLSR or switch, iteratively determines and stores viability information such port viability information for optical wavelength and optical format combinations, or for time slots, in a manner that allows efficient routing updates to be made to neighboring devices. This iterative process can be initiated based on feedback from failed route establishments.

The present invention can be realized in hardware, software, or a combination of hardware and software. An implementation of the method and system of the present invention can be realized in a centralized fashion in one computing system or in a distributed fashion where different elements are spread across several interconnected computing systems. Any kind of computing system, or other apparatus adapted for carrying out the methods described herein, is suited to perform the functions described herein.

A typical combination of hardware and software could be a specialized or general purpose computer system having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. In addition, unless mention was made above to the contrary, it should be noted that all of the accompanying drawings are not to scale. Significantly, this invention can be embodied in other specific forms without departing from the spirit or essential attributes thereof, and accordingly, reference should be had to the following claims, rather than to the foregoing specification, as indicating the scope of the invention.

What is claimed is:

1. A method for summarizing port viability information in a communication network, the method comprising:
establishing a port viability summarization for ports in the communication network, the port viability summarization being used to establish links to use along a routing path;
determining a routing path using the port viability summarization;
detecting a failed route establishment for the routing path;
decreasing the amount of summarization for at least one port determined to have a non-viable link.

2. The method of claim 1, wherein the ports are optical ports and the viability summarization corresponds to a range of wavelengths that are available for egress from a particular ingress port.

3. The method of claim 2, further comprising:
detecting an availability of a wavelength due to a decrease in network utilization; and
increasing the viability summarization for a port having newly available wavelengths.

4. The method of claim 1, wherein the viability summarization corresponds to a range of time slots that are available for egress from a particular ingress port.

5. The method of claim 4, wherein the communication network is a SONET.

6. The method of claim 1, further comprising setting a memory threshold, wherein an initial established port viability summarization for ports in the communication network does not exceed the memory threshold.

7. The method of claim 1, further comprising setting a memory threshold, wherein a port viability summarization for ports in the communication network occupies an amount of memory that is approximately the memory threshold.

8. The method of claim 1, further comprising:
detecting the establishment of a viable route; and
discarding the port summarization.

9. The method of claim 1, further comprising increasing the viability summarization for a port after a predetermined period of time has elapsed.

10. The method of claim 1, wherein the ports are optical ports and the viability summarization corresponds to a range of wavelengths that are not available for egress from a particular ingress port.

11. The method of claim 1, wherein the ports are optical ports and the viability summarization corresponds to a set of ports that are not available for egress from a particular ingress port for a particular range of wavelengths.

12. The method of claim 1, further comprising providing an indication as to whether the port viability summarization is complete.

13. A machine readable storage device having stored thereon a computer program for summarizing port viability information in a communication network, the computer program comprising a set of instructions which when executed by a machine causes the machine to perform a method comprising:
establishing a port viability summarization for ports in the communication network, the port viability summarization being used to establish links to use along a routing path;
determining a routing path using the port viability summarization;
detecting a failed route establishment for the routing path;
decreasing the amount of summarization for at least one port determined to have a non-viable link.

14. The method of claim 13, wherein the ports are optical ports and the viability summarization corresponds to a range of wavelengths that are available for egress from a particular ingress port.

15. The method of claim 14, further comprising:
detecting an availability of a wavelength due to a decrease in network utilization; and
increasing the viability summarization for a port having newly available wavelengths.

16. The method of claim 13, wherein the viability summarization corresponds to a range of time slots that are available for egress from a particular ingress port.

17. The method of claim 16, wherein the communication network is a SONET.

18. The method of claim 13, further comprising setting a memory threshold, wherein an initial established port viability summarization for ports in the communication network does not exceed the memory threshold.

19. The method of claim 13, further comprising:
detecting the establishment of a viable route; and
discarding the port summarization.

20. An apparatus for summarizing port viability information in a communication network, the apparatus comprising:
a central processing unit, the central processing unit:
establishing a port viability summarization for ports in the communication network, the port viability summarization being used to establish links to use along a routing path;
determining a routing path using the port viability summarization;
detecting a failed route establishment for the routing path;
decreasing the amount of summarization for at least one port determined to have a non-viable link; and
a storage unit, the storage unit storing the port viability summarization.

21. The apparatus of claim 20, wherein the apparatus is a GLSR having optical ingress and egress ports, wherein the viability summarization corresponds to a range of wavelengths that are available for egress from a particular ingress port.

22. The apparatus of claim 21, wherein the central processing unit further:
detects an availability of a wavelength due to a decrease in network utilization; and
increases the viability summarization for a port having newly available wavelengths.

23. The apparatus of claim 20, wherein the viability summarization corresponds to a range of time slots that are available for egress from a particular ingress port.

24. The apparatus of claim 20, wherein the initial established port viability summarization for ports in the communication network does not exceed a predetermined memory threshold.

25. The apparatus of claim 20, wherein the central processing unit further:
detects the establishment of a viable route; and
deletes the port summarization from the storage device.

26. The apparatus of claim 20, the apparatus is a GLSR having optical ingress and egress ports, wherein the viability summarization corresponds to a range of wavelengths that are not available for egress from a particular ingress port.

27. The apparatus of claim 20, the apparatus is a GLSR having optical ingress and egress ports, wherein viability summarization corresponds to a set of ports that are not available for egress from a particular ingress port for a particular range of wavelengths.

28. The apparatus of claim 20, wherein the central processing unit further provides an indication as to whether the port viability summarization is complete.
